(19) United States
(12) Patent Application Publication
(10) Pub. No.: US 2009/0276703 A1
(43) Pub. Date: Nov. 5, 2009

(54) PROFILE-BASED HELP FOR METAVERSE APPLICATIONS

(76) Inventors: Angela Richards Jones, Durham, NC (US); Fu Yi Li, Sudbury, MA (US); Ruthie D. Lyle, Durham, NC (US); Vandana Mallempati, Austin, TX (US); Pamela Ann Nesbitt, Tampa, FL (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 12/113,226

(22) Filed: May 1, 2008

(51) Int. Cl. G06F 3/00

(52) U.S. Cl. 715/705

(57) ABSTRACT

A method, medium and implementing processing system are provided for enabling enhanced help or guidance that is tailored to a user and is available on a multitude of “levels” and in a variety of ways. A user is enabled to create a user profile by inputting information about his or her personal interests, i.e. what they plan or hope to do in a virtual world application and possibly how the application can best meet the individual's needs. Users are enabled to specify interests using a form, free-form text, or other means of input. Based on the user input specifications, and depending upon user activity while in the metaverse application, information will be provided about users, places, and events that may be useful to the user in accomplishing the individual user's objectives.

### FIELD OF THE INVENTION

The present invention relates generally to information processing systems and more particularly to a methodology and implementation for providing profile-based help in interactive applications.

### BACKGROUND OF THE INVENTION

Currently, there are computer-based applications that are designed to emulate real life situations in which the players are presented with real life situations and enabled to make choices among screen objects and take actions relative to displayed situations on a display screen. Using a “joystick”, a player is able to move a player icon or “avatar” on a display screen relative to the displayed environment and the displayed situation changes depending upon the actions taken by the player. These “virtual life” or “metaverse applications” are also referred to as “alternate reality applications”, and/or “virtual reality applications” among others, and can be executed either locally from a user's computer system or from a game server which may be interconnected with other servers and other user systems.

When a new user registers in a metaverse application, they traditionally create a simple profile with the name of the avatar and a few other things such as an initial avatar look. The freeform nature of these virtual worlds, by virtue of the fact that they are representations of the real world, offer limited help other than to teach the user how to translate movements and actions which would be performed in the real world into the two-dimensional world of the virtual environment. Also things which are not possible in real life such as flying are explained. Beyond that, the user is basically on his own with the freedom to do what he wishes and to go where he wants. For example in an exemplary metaverse application, the user gets some directions to go to certain locations and also has the ability to display maps. However it is a one-size-fits-all approach. This can leave the new user of a metaverse application confused as to what to do and where to go. It can also prevent the user from having a meaningful experience and/or from doing anything creative. For example if the new user goes to a first site and after that realizes it does not address his needs then there is no help for the user to go to different site which will be an exact match to what the particular user desires.

Therefore, there is a need for a system and methodology for metaverse or virtual reality applications which provide automatic help and enable a user to take actions which are more directly related to the objectives and/or topics of interest to the particular user.

### SUMMARY OF THE INVENTION

A method, medium and implementing processing system are provided for enabling enhanced help or guidance that is tailored to a user and is available on a multitude of “levels” and in a variety of ways. A user is enabled to create a user profile by inputting information about his or her personal interests, i.e. what they plan or hope to do in a virtual world or other interactive application and possibly how the application can best meet the individual's needs. Users are enabled to specify interests using a form, free-form text, or other means of input. Based on the user input specifications, and depending upon user activity while in the application, information will be provided about users, places, and events that may be useful to the user in accomplishing the individual user's objectives.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is a block diagram showing several of the major components of the system shown in FIG. 1;

FIG. 3 is an illustration of a displayed user preference input screen useful in explaining an exemplary operation of the present invention;

FIG. 4 is an illustration of an exemplary displayed screen which may be presented to a user while in a metaverse application;

FIG. 5 is a screen display which may be presented to a user in accordance with an exemplary implementation of the present invention; and

FIG. 6 is a flow chart illustrating an exemplary operation of the present invention.

### DETAILED DESCRIPTION

The various methods discussed herein may be implemented within a computerized system which includes processing means, memory, updateable storage, input means and display means. The exemplary application may be executed from a single user computerized system or it may be coupled through an interconnection network to other users and/or server systems for enhanced effects. Since the individual components of a system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a user application running on a single computer system, it is understood that disclosed methodology may also be applied in many other available and future devices, applications and systems to achieve the beneficial functional features described herein. Further, even though the exemplary embodiment disclosed herein is a metaverse application, it is understood that the present invention is not limited to metaverse applications and that features described herein may also be implemented in other interactive applications including virtual reality and other interactive visual games, or applications including games or applications in which a joystick is used as an input device.

In accordance with the present disclosure, enhanced help or guidance which can be tailored to the user, is available on a multitude of “levels” and is provided in a variety of ways. A user is enabled to input his or her own profile containing the user's preferences and/or objectives. For example, a user inputs information about what the user's interests are, what the user plans or hopes to do in the metaverse application and possibly how the application can best meet their needs. Based on the user's actions or inactions while in a metaverse application for example, the need for personalized help is detected and personalized “Help” tailored to the user profile is then automatically delivered to the user. The determination of the need for “Help” can be made in many ways. For example, the need for “Help” can be made by a user selecting a “Help” icon or button on the display screen, or by the application detecting an inactivity period in which the user does not move a controlled avatar.

Several mechanisms are disclosed for providing personalized Help to the user. Targeted guidance is provided i.e. upon login, a set of instructions are given to achieve a goal. For example in one application, if the user completes the profile stating the user interests as art collection, then the Help will alert the user when he or she is near stores that sell art, art galleries, events where the subject matter is related to art or people who have art for sale in their inventory. Without the targeted guidance of personalized Help, the user may have to wander around aimlessly and only by luck would the user be able to find something of interest.

Another feature is available for implementing periodic guidance, i.e. when the user appears to need help, a popup appears suggesting activities or things to do, places to go, etc. which have to do with the user's defined interests. This help could also be delivered by the real-time creation of a signpost near the avatar visible only to them with arrows pointing in directions which will lead them to places of interest to them.

The help level is also tunable and persists until changed. For example beginning users might want almost immediate help with detailed instructions every time they falter or stop whereas experienced users might wish to get very limited help only when they look really lost. Help could also be turned off completely.

In one example, the system detects that the user needs help by monitoring the behavior, i.e. the activity or inactivity, of the avatar. For example, it may be determined that Help is needed if there is a lack of activity, an idleness or “spinning” (doing something nonsensical or other predetermined actions) on the part of the avatar, or by detecting a predetermined keystroke or other input delivered by the user when help is desired.

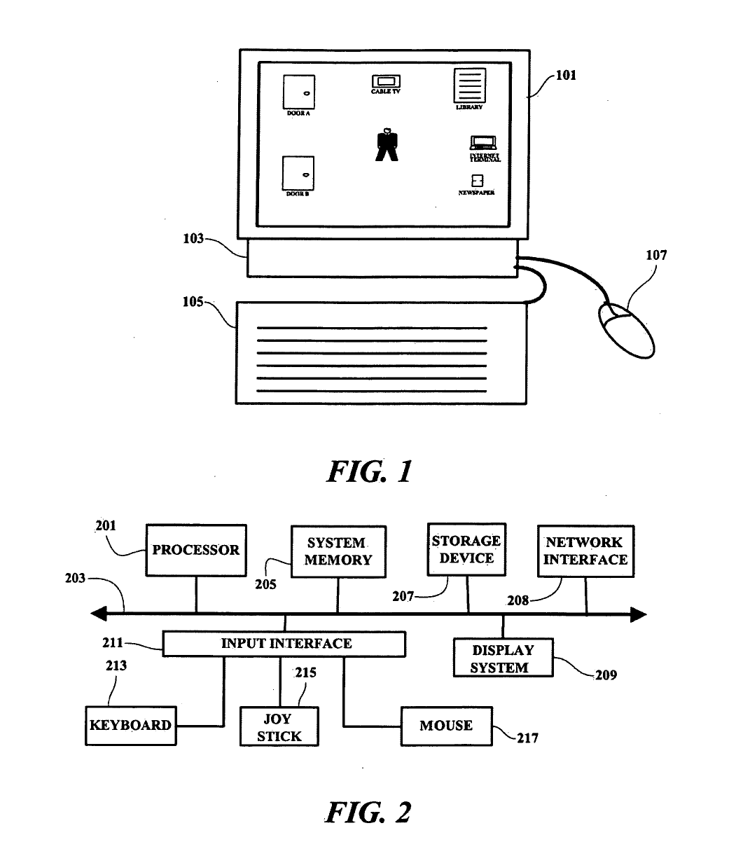

In FIG. 1, there is shown a display device 101 and a control box 103 in which various sub-systems are contained to support the playing of a metaverse application. In the example, a keyboard 105 and/or mouse 107 may be used as user input devices. A joystick (not shown) may also be used as an input device for other applications.

In FIG. 2, several of the major components of the control box 103 are illustrated. As shown, the electronics includes a processor system 201 which is coupled to a main bus 203. Also connected to the bus 203 are a system memory 205, a storage system 207 and a network interface 208. The metaverse application may be stored locally on the storage device 207 or coupled through the network interface 208 to a game server and possibly other users on other systems. FIG. 2 also shows an input interface 211 which is arranged to receive inputs from a keyboard 213, a mouse 217 or, in other applications, a joystick 215. The system also includes a display system 209 connected to the main bus 203.

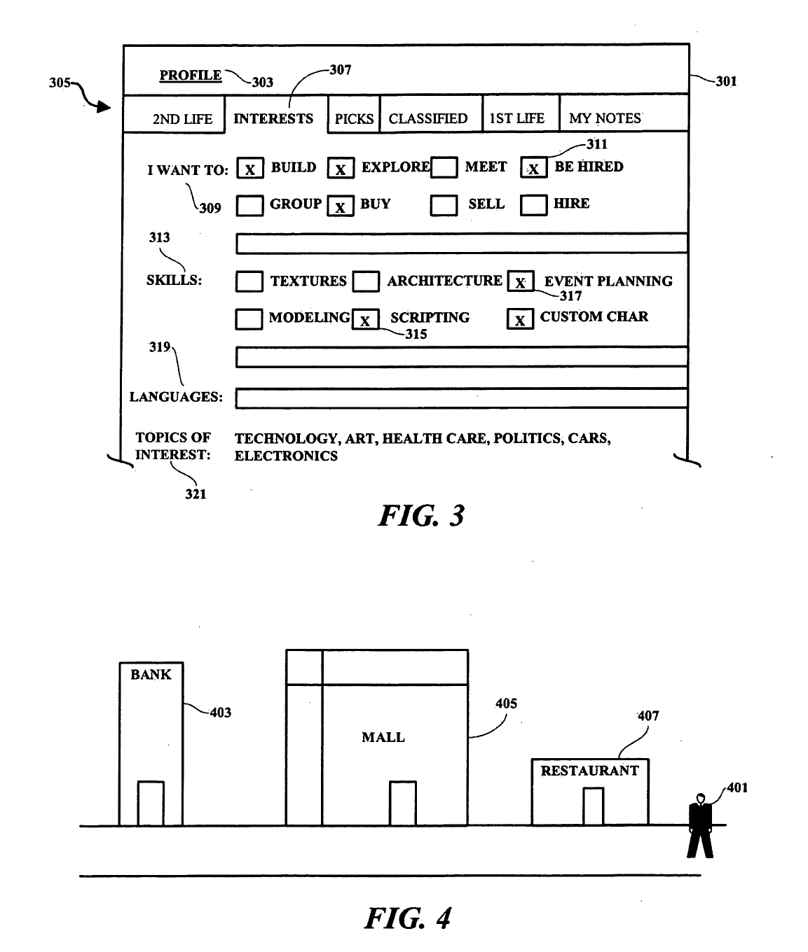

With reference to FIG. 3, as hereinbefore noted, when a user first logs-in to the metaverse application, an input profile screen 301 is presented. The profile screen 301 includes a profile section 303 to receive input from the user. The profile screen 301 has several tabs 305 including an “Interests” tab 307. In one section, the user is enabled to input what the user wants to do 309 in the metaverse application. For example, if the user wishes to be hired 311, an appropriate box is checked. In another input section 313, the user is enabled to input special skills that the user may have. In the illustrated example, the user checks a “scripting” entry 315 and an “event planning” block 317. The user may also input any language proficiency the user may have 319. The language input will enable the user to converse with avatars in the application who speak the input languages. In another section, the user is enabled to input items of particular interest to the user 321. In the is example, the user has indicated special topics of interest to include “technology”, “art”, “health care”, “politics”, “cars” and “electronics”. These topics of interest, skills and desires of the user are used by the metaverse application in providing personalized “Help” alerts to the user within the metaverse application.

FIG. 4 illustrates an exemplary environment or situation in which the user may find himself. As shown, the avatar 401 is on a street where several places are located. Among the places to which the player may move the avatar are a bank 403, a shopping mall 405 and a restaurant 407. By manipulating the input devices, the user is enabled to move the avatar to the door of the shopping mall 405 at which time a new series of screens will be presented to the user. The user may continue from this point to move the avatar to any store in the mall 405 to shop for any item which the user may wish to price or buy. In the illustrated example shown in FIG. 4, if the avatar does not move from a given position for a predetermined period of time, or continues to walk back and forth from the bank 403 to the restaurant 407, the system will sense this predetermined condition and interpret this apparent indecision on the part of the avatar as an indication that the user needs help in directing or moving the avatar 401. When such aimless behavior, or other predetermined behavior such as, inter alia, a period of inactivity, is detected, a Help process will be initiated, and by referencing the user's input to the profile database (FIG. 3), Help will be provided to the user to suggest a move that will serve the user's desires, and relate to the user's interests and skills.

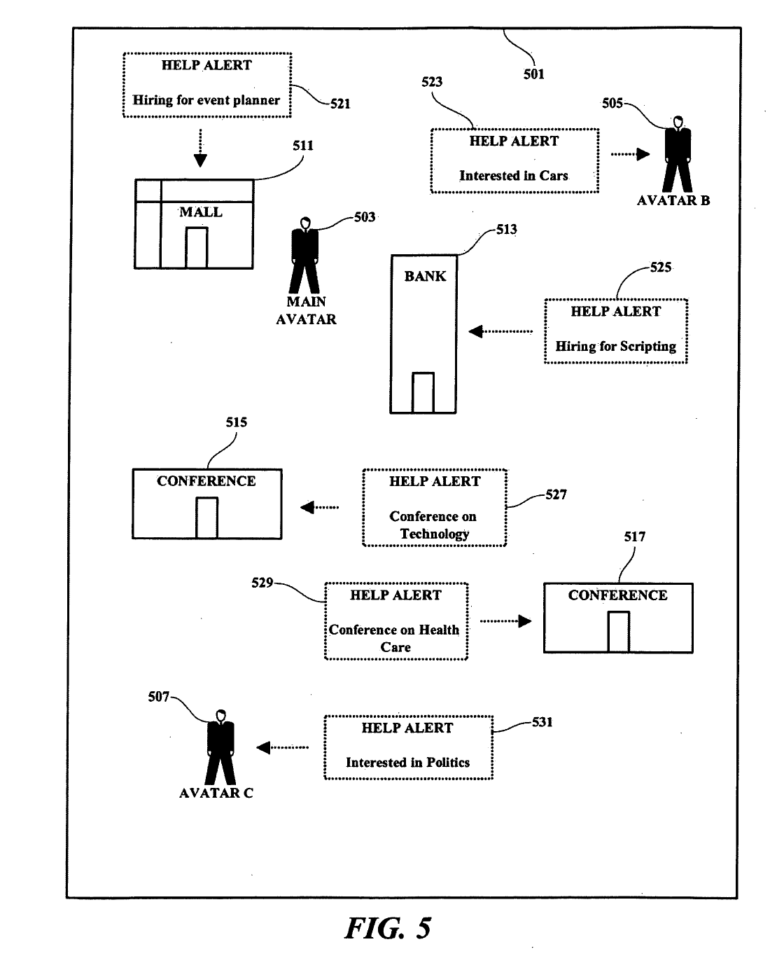

In the FIG. 5 illustration, an application screen 501 shows a main Avatar 503 which is controlled by the user. Also shown in the exemplary screen are various places including a mall 511, a bank 513, and two conference centers 515 and 517. Two other Avatars, Avatar B 505 and Avatar C 507, are also illustrated. Avatars B and C are presented by the metaverse application and are not controlled by the user. When the main Avatar 503 is within the environment shown, and it is detected that the user needs or wants Help with his or her next move, the user's profile is accessed and a series of “Help Alert” windows are presented. In the example, one Help Alert 521 indicates that the Mall 511 is hiring an Event Planner. In other examples, the user can see that Avatar B 505 is interested in cars 523, the Bank 513 is hiring for Scripting 525, Conference Hall 515 is currently having a conference on Technology, and Conference Hall 517 is currently having a conference on Health Care 529. It is also noted in the example that Avatar C 507 is interested in Politics 531. The user is now able to select his or her next move depending upon which interest the user wishes to pursue at the current time. It is noted that perhaps only a single Help Alert may be presented on a given screen situation but many are shown in the drawing for purposes of illustration.

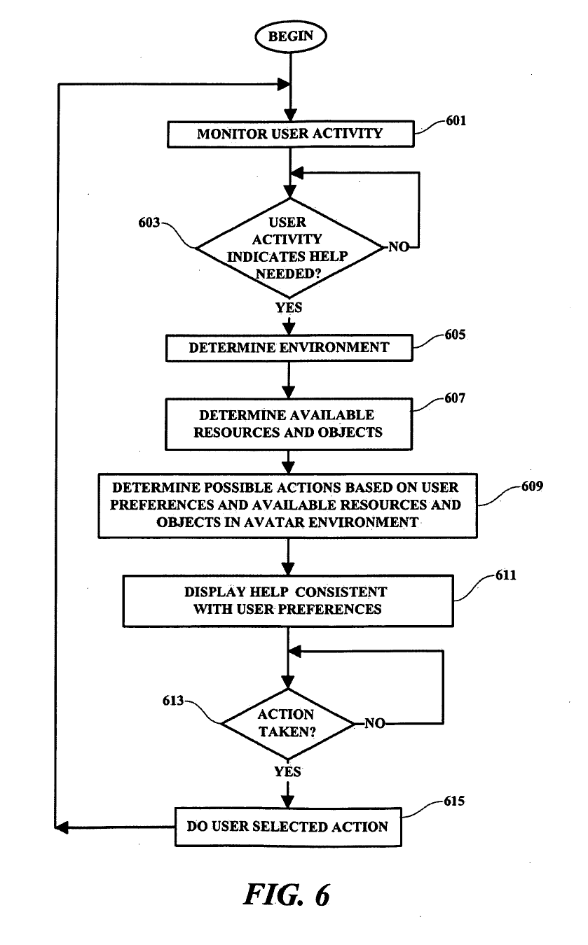

FIG. 6 illustrates an exemplary flow sequence which may be implemented in accordance with the present invention. As shown, the user's activity is monitored 601 as the user moves through the metaverse application. As hereinbefore noted, when it is detected, either through avatar inactivity or aimless or repetitious movements, inter alia, that the user needs Help 603, then the system determines the avatar's environment 605, determines the available resources and objects 607 and the possible actions that the user may take consistent with and based upon the user preferences 609 which the user has previously indicated and/or input. Help, consistent with the user's preferences including the user's input desires, skills and topics of interest, is then displayed 611 to the user. In the example, Help is provided in the form of displayed Help Alert panels although Help may be presented in other forms, including visual and/or audio and other non-text forms, as well. The Help Alerts are based upon the avatar's situation, the availability of resources and objects, and the user's desires, skills and interests. After the user takes another action 613, and the avatar is moved 615, the system returns to again monitor the avatar's activity 601 for an indication that user personalized Help is again needed by the user.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including portable or fixed, volatile or non-volatile memory media device, including CDs, RAM and “Flash” memory, or other semiconductor, optical, magnetic or other memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for providing personalized help to a user of an interactive application being executed on a computer system in which said user is enabled to move an avatar on a display screen presenting various environments of said application, said method comprising:
obtaining a list of user preferences for avatar actions in different environments presented by said application;
determining when said user needs help in moving said avatar within a displayed application environment; and
using said user preferences in providing said help to said user when it is determined that said user needs help.

2. The method as set forth in claim 1 wherein said list of user preferences is input to said application by said user.

3. The method as set forth in claim 1 and further including:
monitoring behavior of said avatar within said application; and
determining when said user needs help in moving said avatar by detecting predetermined behavior of said avatar within said application.

4. The method as set forth in claim 3 wherein said behavior is determined by detecting inactivity of said avatar for a predetermined period of time.

5. The method as set forth in claim 3 wherein said behavior is determined by one or more predetermined movements of said avatar.

6. The method as set forth in claim 1 wherein said help is provided as help text within a help window, said help text providing suggestions to said user for movement of said avatar consistent with said user preferences.

7. The method as set forth in claim 1 wherein said help is provided to said user in a form other than a presentation of help text in a help window.

8. The method as set forth in claim 4 and further including:
enabling said user to select a help level, said help level being selectable to determine a quantitative measure of said predetermined behavior necessary to be detected before providing said help to said user.

9. A medium programmed for providing personalized help to a user of an interactive application being executed on a computer system in which said user is enabled to move an avatar on a display screen presenting various environments of said application, said medium being readable by a computing device for providing program signals effective for:
obtaining a list of user preferences for avatar actions in different environments presented by said application;
determining when said user needs help in moving said avatar within a displayed environment; and
using said user preferences in providing said help to said user when it is determined that said user needs help.

10. The medium as set forth in claim 9 wherein said list of user preferences is input to said application by said user.

11. The medium as set forth in claim 9 wherein said program signals are further effective for:
monitoring behavior of said avatar within said application; and
determining when said user needs help in moving said avatar by detecting predetermined behavior of said avatar within said application.

12. The medium as set forth in claim 11 wherein said behavior is determined by detecting inactivity of said avatar for a predetermined period of time.

13. The medium as set forth in claim 11 wherein said behavior is determined by one or more predetermined movements of said avatar.

14. The medium as set forth in claim 9 wherein said help is provided as help text within a help window, said help text providing suggestions to said user for movement of said avatar consistent with said user preferences.

15. The medium as set forth in claim 9 wherein said help is provided to said user in a form other than a presentation of help text in a help window.

16. The medium as set forth in claim 12 wherein said program signals are further effective for:
enabling said user to select a help level, said help level being selectable to determine a quantitative measure of said predetermined behavior necessary to be detected before providing said help to said user.

17. A system for providing personalized help to a user of a application being executed on a computer system in which said user is enabled to move an avatar on a display screen presenting various environments of said application, said system comprising:
input means for obtaining a list of user preferences for avatar actions in different environments presented by said application;
means for determining when said user needs help in moving said avatar within a displayed environment; and
means for using said user preferences in providing said help to said user when it is determined that said user needs help.

18. The system as set forth in claim 17 wherein said list of user preferences is input to said application by said user.

19. The system as set forth in claim 17 and further including:
monitoring behavior of said avatar within said application; and
determining when said user needs help in moving said avatar by detecting predetermined behavior of said avatar within said application.

20. The system as set forth in claim 19 wherein said behavior is determined by detecting inactivity of said avatar for a predetermined period of time.
